(19) United States
(12) Patent Application Publication
(10) Pub. No.: US 2002/0020211 A1
(43) Pub. Date: Feb. 21, 2002

(54) Method for testing a completely or partially assembled combustion engine

(75) Inventors: Robert Lambertz, Neuss (DE); Thomas Thissen, Geldern (DE)

Correspondence Address: Lerner and Greenberg, P.A., P.O. Box 2480, Hollywood, FL, 33022, US

(73) Assignee: ABB Patent GmbH

(21) Appl. No.: 09/900,669

(22) Filed: Jul. 6, 2001

Related U.S. Application Data
(63) Continuation-in-part of application No. 08/996,496, filed on Dec. 23, 1997, now abandoned.

(30) Foreign Application Priority Data
Dec. 23, 1996 (DE) 196 54 137.9

(51) Int. Cl. G01L 3/26

(52) U.S. Cl. 73/116

(57) ABSTRACT

Methods for testing a completely or partially assembled combustion engine have heretofore made use of orifices with preset flow cross-sections, with the result that it was not possible for pressure arising in a combustion chamber to be adapted to varying measuring cycles. In order to make an optimum air-mass flow available to a particular measuring step, the flow cross-section of the orifices is adjusted as a function of a test program. The optimum air-mass flow is also made possible by subjecting the combustion chamber to a pressure which is greater than the ambient pressure of the combustion engine.

### CROSS-REFERENCE TO RELATED APPLICATION

This application is a continuation-in-part of copending application No. 08/996,496, filed Dec. 23, 1997, now abandoned.

### BACKGROUND OF THE INVENTION

1. Field of the Invention:

The invention relates to a method for testing a completely or partially assembled combustion engine for assembly faults and/or manufacturing faults, which includes driving the combustion engine to overrun, connecting an orifice upstream of at least one entrance or exit of the combustion engine to produce certain pressure and flow conditions, and, in particular, using measured values of pressure and torque for the evaluation.

Such a method is disclosed in European Patent 0 456 244 B1. In that method, pin-hole orifices are assigned to an induction and exhaust manifold to determine induction vacuum and exhaust-gas back pressure. Those measures serve to compensate for a low overrun speed of rotation and a low gas-exchange. frequency associated therewith. The cross-section of such orifices may first be figured in advance in an analytical way, with the cross-section that is ultimately used being determined empirically with the aid of series of measurements. In that method, the specified cross-section remains constant and has to be a usable compromise for all measuring cycles. The pressure building up in the combustion chamber cannot be adapted to varying measuring cycles.

### SUMMARY OF THE INVENTION

It is accordingly an object of the invention to provide a method for testing a completely or partially assembled combustion engine, which overcomes the hereinafore-mentioned disadvantages of the heretofore-known methods of this general type and which makes an optimum air-mass flow for a particular measuring step available to a test piece.

With the foregoing and other objects in view there is provided, in accordance with the invention, a method for testing a completely or partially assembled combustion engine for assembly and/or manufacturing faults, which comprises driving a combustion engine to overrun; connecting an orifice upstream of at least one entrance or exit of the combustion engine to produce certain pressure and flow conditions; in particular using measured values of pressure and torque for evaluation; and adjusting a flow cross-section of the orifice as a function of requirements for testing.

The adjustment capability of the flow cross-section results in the optimum airmass flow, and therefore in the greatest possible dynamics of the measuring signals. Furthermore, selected fault diagnoses can be made by changing the requirement for the testing.

With the objects of the invention in view there is also provided a method for testing a completely or partially assembled combustion engine for assembly and/or manufacturing faults, which comprises driving a combustion engine to overrun; connecting an orifice upstream of at least one entrance or exit of the combustion engine to produce certain pressure and flow conditions; in particular using measured values of pressure and torque for evaluation; and subjecting at least a combustion chamber of the combustion engine to a pressure higher than ambient pressure of the combustion engine.

With a greater air mass in the combustion chamber there is, for example, given overrunning drive, an increase in the compression work to be performed, with the result that faults which may lead to losses in compression can be detected more clearly.

Apart from the combustion chamber, it is also possible for other regions of the engine interior to be subjected to increased pressure in order to use the variations in pressure to indicate faults for the measuring step selected in each case. Thus, in order to detect faults, use is made, for example, of the internal pressure acting in the region of the respective induction and exhaust-gas side as well as of the variation in that pressure.

In accordance with a concomitant mode of the invention, the requirements for the testing are incorporated into a test program.

This permits an individually adaptable measuring assembly for production lines with a number of models down to a batch size of “1”. Its use is also possible in conjunction with an expert system.

In one embodiment, the invention has the feature that the orifice is not an integral part of the combustion engine. Instead, the orifice is part of the testing apparatus and, therefore, can be used in testing various different combustion engines. This makes it possible to select a particular orifice depended on the requirements for testing independently of any (pre)existing orifice of the combustion engine.

In another embodiment, the invention has the feature that the combustion engine is driven to overrun using an external force and the measured values of pressure and torque of the external force is used for evaluation of the combustion engine.

In another embodiment, the invention has the feature that a chosen interior compartment of the combustion engine is subjected to a pressure higher than ambient pressure before or independently of any compressions due to movements of parts of the combustion engine. Hence, it is possible to subject a chosen interior compartment of the combustion engine to a desired pressure in dependence on the requirements for testing, independently of any compression due to movements of parts of the combustion engine.

In another embodiment, the invention has the feature that the combustion engine can be completely or partially assembled.

Other features which are considered as characteristic for the invention are set forth in the appended claims.

Although the invention is illustrated and described herein as embodied in a method for testing a completely or partially assembled combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view through part of a combustion engine;

FIG. 2 is a torque diagram; and

FIG. 3 is an oil pressure diagram.

### DESCRIPTION OF THE PREFERRED EMBODIMENTS

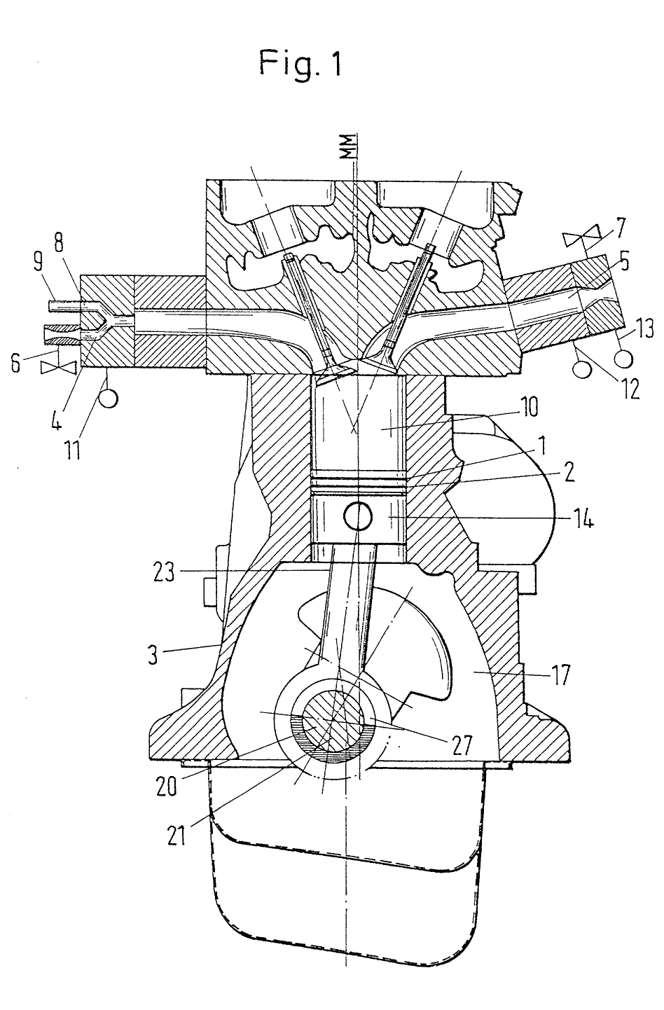

Referring now to the figures of the drawings in detail and first, particularly, to FIG. 1 thereof, there is seen a diagrammatic representation of a basic structure for carrying out a method according to the invention. The test method will be explained by using a first example, in which faults at compression rings 1 and 2 are assumed as a requirement for testing. In the case of a combustion engine 3 to be tested, an assembly of the engine is advanced to a stage at which a gas pressure can build up in an engine compartment of the combustion engine during overrunning operation. The engine can thus be partially assembled or completely assembled.

Orifices 6, 7 which are respectively connected upstream of an induction port 4 and an exhaust-gas port 5, are each set through a non-illustrated adjusting device to a predeterminable flow cross-section. The combustion engine or test piece 3 to be tested is overrun or towed at a predeterminable speed of rotation. A connection piece 9, which is fitted on a port 8 of the induction side, is acted upon by a non-illustrated compressed-air source for the reliable determination of a possible fault at the compression rings 1, 2, or upon some of them or all of them being missing. A combustion chamber 10, and therefore a further interior of the combustion engine 3 disposed next to the combustion chamber as well, is subjected to a pressure which is higher than the ambient pressure through this connection piece 9. There is an increase in the compression work to be performed by increasing the air mass to be compressed in the combustion chamber 10, with the result that losses in compression and a change which can be derived therefrom, in the measured values of the overrunning torque, are more clearly evident. The orifice or orifice plate 6 can be brought into a closed position while this supporting pressure is being applied. Adjustment of the orifice or orifice plate 7 disposed on the exhaust-gas side permits continuous influence over the air-mass flow which is flowing off. The respectively optimum air-mass flow for detecting a fault during the particular measuring step is determined by a non-illustrated measuring computer. This method is also used to determine the flow cross-sections of the orifices and to activate their non-illustrated setting devices. The particular test program of the measuring computer also causes a certain supporting pressure to be applied. A pressure-measuring point 11 on the induction side relays the pressure value prevailing there to the measuring computer. Pressure-measuring points 12, 13 which are disposed on the exhaust-gas side in front of and behind the orifice 7 also relay their measured values for the evaluation. The pressure variations on the induction side and on the exhaust-gas side, like the compression work to be performed, as well as the pressure variations in the combustion chamber, are dependent on the air mass which is made available to the engine.

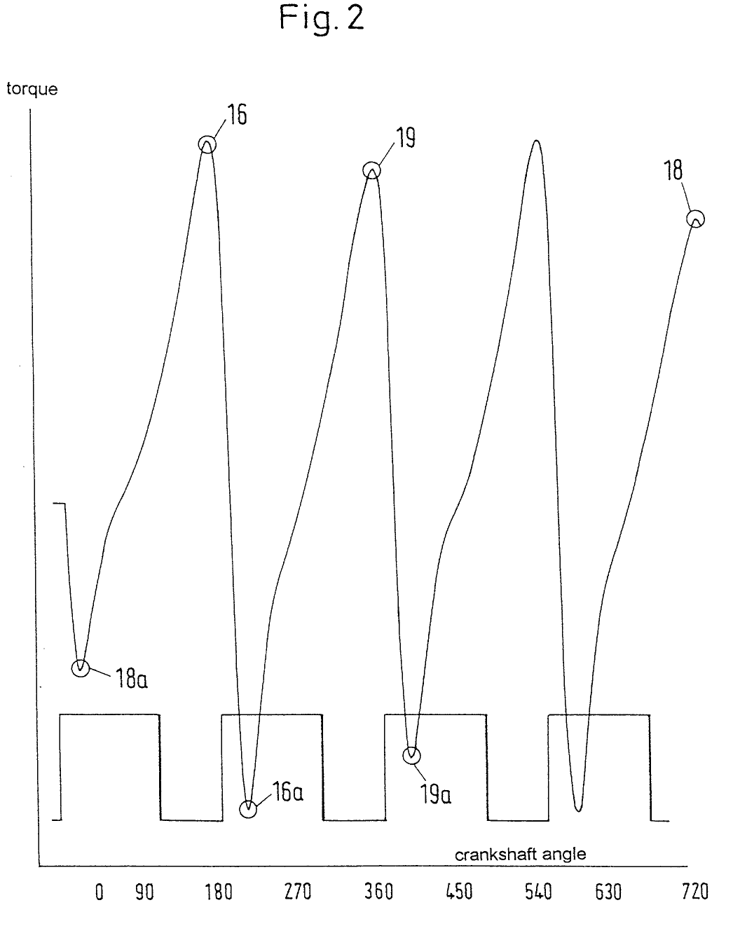

A diagram illustrated in FIG. 2 shows various measured values of torque which are plotted as a function of the crankshaft angle. If an air mass having a greater pressure than the ambient pressure is introduced through the port 8 of the induction side into the interior of the combustion engine 3, a relatively high overrunning torque, which is symbolized by a curve peak 16, occurs because of the compression work to be performed by the volume of air located in the combustion chamber 10, when the compression rings 1, 2 are installed free of faults, since the electric motor performing the overrunning has to maintain a predeterminable speed of rotation. The torque returning to the electric motor from the overrunning combustion engine is correspondingly low, in accordance with a curve peak 16a.

The compression ring 1 facing the combustion chamber 10 takes on the major part of the sealing with respect to a crank case 17. Its omission therefore leads to a lower moment of overrun of the electric motor performing the overrunning, as is symbolized by reference numeral 18, due to the lower compression work in the combustion chamber 10. A torque value 18a returned by the combustion engine 3 to the electric motor is revealingly different from the curve peak 16a. Curve points 19 and 19a, which represent the omission of the compression ring 2 facing the crank case 17, are clear evidence or information due to their respective distances from the points 16, 16a and 18, 18a. In particular, when the compression ring 1 is omitted, the evidence or information may be consolidated by a pressure measurement at a non-illustrated point of the crank case 17, since some of the air mass introduced by supporting pressure escapes into the crank case 17 during compression.

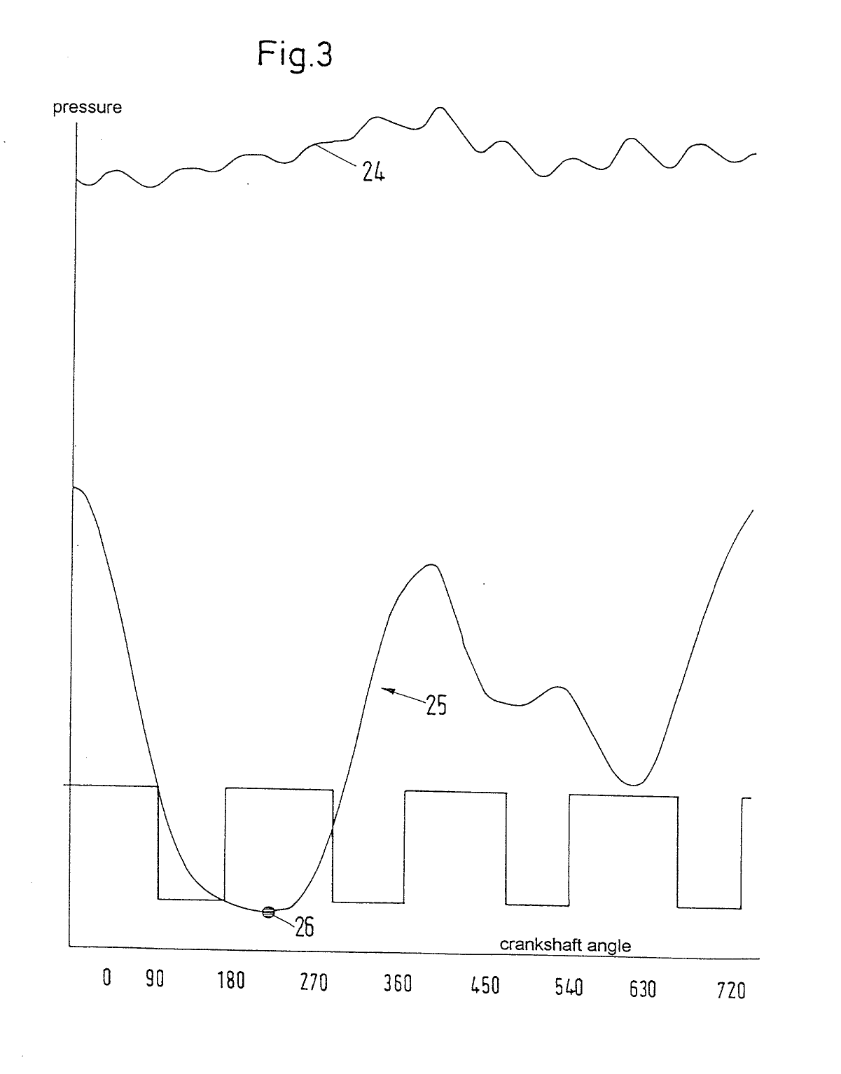

With reference to another exemplary embodiment, a fault is detected in the region of a connecting-rod bearing 23. In order to check for the source of this fault, the air-mass flow is regulated by adjusting the flow cross-section of the orifice 6 disposed in the induction region, until it has reached the optimum mass. The air-mass flow required for the particular testing task, and therefore the opening cross-section of the orifices 6 and 7, is determined by the measuring computer and transferred to adjusting devices of the orifices by corresponding control commands. The measuring computer prescribes a reduced air-mass flow which requires a corresponding setting of the orifices for the above-mentioned “connecting-rod bearing” testing task. A vacuum is produced in this case, due to this reduction in the air-mass flow and because of the increase in size of the combustion chamber during induction through a downwards movement of the piston 14. A force therefore acts from below on the piston during the induction cycle. This force causes a crankshaft journal to lie in a bearing bushing. At the same time, non-illustrated crankshaft main bearings are directly supplied with oil by a pressure line. Due to grooves in the main-bearing bushings, a pressure builds up against a crankshaft 20, with the result that oil passes through bores 21 in the crankshaft to the crankshaft journal. The connecting-rod bearing 23 is supplied with oil through these oil bores. A displacement calculation reveals that the crankshaft journals are raised out of the bearing bushings for a short time, when a piston 14 is oscillating, and the oil bores become free. An upper curve 24 of the diagram in FIG. 3 shows an oil-pressure variation in a manner similar to the oscillating movement. The curve variation 24 serves as a reference curve for a connecting-rod bearing which is fitted in a fault-free manner and has manufacturing tolerances that are within a permissible range. A lower curve 25 symbolizes an inadmissible bearing clearance of 0.5 mm due to a clear drop in oil pressure at a crankshaft angle of about 220° according to reference numeral 26. If the fall in pressure is even greater, this is proof that a bearing-bushing half 27 is missing. In the above-described example, the orifice adjustment is used, together with an oil-pressure check of the lubricating oil, as an indicator of faulty assembly or of a manufacturing fault. Pressure values, such as in the region of the orifice 7 on the exhaust-gas side, may be used to determine other faults.

We claim:

1. A method for testing a completely or partially assembled combustion engine for at least one of assembly and manufacturing faults, which comprises:
driving a completely or partially assembled combustion engine by an external force;
connecting an orifice not being a part of the combustion engine for testing the completely or partially assembled combustion engine, the orifice located upstream of at least one entrance or downstream of at least one exit of the completely or partially assembled combustion engine in dependence on requirements for testing in order to produce certain pressure and flow conditions; and
adjusting a flow cross-section of the orifice for testing the completely or partially assembled combustion engine in dependence on the requirements for testing.

2. The method according to claim 1, which comprises measuring values of pressure and torque of the external force and using the measured values of pressure and torque for evaluation.

3. The method according to claim 1, which comprises incorporating the requirements for testing into a test program.

4. The method according to claim 1, wherein the adjusting step is performed with an adjustable orifice.

5. A method for testing a completely or partially assembled combustion engine for at least one of assembly and manufacturing faults, which comprises:
driving a completely or partially assembled combustion engine by an external force;
connecting an orifice not being a part of the combustion engine for testing the completely or partially assembled combustion engine, the orifice located upstream of at least one entrance or downstream of at least one exit of the completely or partially assembled combustion engine in dependence on requirements for testing in order to produce certain pressure and flow conditions; and
subjecting a chosen interior compartment of the completely or partially assembled combustion engine to a pressure higher than ambient pressure independently of any compression due to movements of parts of the combustion engine, for testing the completely or partially assembled combustion engine in dependence on the requirements for testing.

6. The method according to claim 5, which comprises measuring values of pressure and torque of the external force and using the measured values of pressure and torque for evaluation.

7. The method according to claim 5, which comprises incorporating the requirements for testing into a test program.

8. A method for testing a completely or partially assembled combustion engine for at least one of assembly and manufacturing faults, which comprises:
driving a completely or partially assembled combustion engine by an external force;
connecting an orifice not being a part of the combustion engine for testing the completely or partially assembled combustion engine, the orifice located upstream of at least one entrance or downstream of at least one exit of the completely or partially assembled combustion engine in dependence on requirements for testing in order to produce certain pressure and flow conditions;
adjusting a flow cross-section of the orifice for testing the completely or partially assembled combustion engine in dependence on the requirements for testing; and
subjecting a chosen interior compartment of the completely or partially assembled combustion engine to a pressure higher than ambient pressure independently of any compression due to movements of parts of the combustion engine, for testing the completely or partially assembled combustion engine in dependence on the requirements for testing.

9. The method according to claim 8, which comprises measuring values of pressure and torque of the external force and using the measured values of pressure and torque for evaluation.

10. The method according to claim 8, which comprises incorporating the requirements for testing into a test program.

11. The method according to claim 8, wherein the adjusting step is performed with an adjustable orifice.
